(19) United States
(12) Patent Application Publication
(10) Pub. No.: US 2026/0369668 A1
(43) Pub. Date: Nov. 19, 2026

(54) METHOD FOR MANUFACTURING SULFIDE SOLID ELECTROLYTE

(71) Applicant: IDEMITSU KOSAN CO.,LTD., Tokyo (JP)

(72) Inventor: Yusuke ISEKI, Chiyoda-ku, Tokyo (JP)

(73) Assignee: IDEMITSU KOSAN CO.,LTD., Tokyo (JP)

(21) Appl. No.: 19/153,648

(22) PCT Filed: Jan. 26, 2024
(86) PCT No.: PCT/JP2024/002430

§ 371 Date: Aug. 5, 2025

(30) Foreign Application Priority Data
Feb. 9, 2023 (JP) 2023-018646

(51) Int. Cl. H01M 10/0562; H01M 10/0525

(52) U.S. Cl. CPC H01M 10/0562; H01M 10/0525; H01M 2300/008

(57) ABSTRACT

To provide a method for producing a sulfide solid electrolyte excellent in reaction rate and quality by a method for producing the sulfide solid electrolyte including mixing a raw material-containing substance containing a lithium atom, a phosphorus atom, a sulfur atom and a halogen atom, a complexing agent, an aromatic hydrocarbon solvent, and an aliphatic hydrocarbon solvent.

### TECHNICAL FIELD

The present invention relates to a method for producing a sulfide solid electrolyte.

### BACKGROUND ART

In recent years, with the rapid spread of information-related devices and communication devices, such as personal computers, video cameras, and mobile phones, the development of batteries used as a power source for the devices has been regarded as important. Conventionally, electrolytic solution containing flammable organic solvents have been used in batteries used for such applications, however by making the battery all-solid, a battery in which the electrolytic solution is replaced with a solid electrolyte layer has been developed because a flammable organic solvent is not used in the battery, simplification of safety devices is achieved, and the production cost and productivity are excellent.

As a method for producing a solid electrolyte, PTL 1 discloses a method for producing a sulfide solid electrolyte in which a raw material-containing substance containing a lithium element or the like and a complexing agent are mixed.

### CITATION LIST

### Patent Literature

PTL 1: WO 2020/105737 A

### SUMMARY OF INVENTION

### Technical Problem

An object of the present invention is to provide a method for producing a sulfide solid electrolyte having excellent reaction rate and excellent quality.

### Solution to Problem

The method for producing a sulfide solid electrolyte according to the present invention is a method for producing a sulfide solid electrolyte including mixing a raw material-containing substance containing a lithium atom, a phosphorus atom, a sulfur atom, and a halogen atom, a complexing agent, an aromatic hydrocarbon solvent, and an aliphatic hydrocarbon solvent.

### Advantageous Effects of Invention

According to the present invention, it is possible to provide a method for producing a sulfide solid electrolyte having excellent reaction rate and excellent quality.

### BRIEF DESCRIPTION OF DRAWINGS

FIG. 1 is a graph showing a relationship between an amount of residual diphosphorus pentasulfide and a stirring time in Example 1.

FIG. 2 is a graph showing a relationship between an amount of residual diphosphorus pentasulfide and a stirring time in Example 2.

FIG. 3 is a graph showing a relationship between an amount of residual diphosphorus pentasulfide and a stirring time in Example 3.

FIG. 4 is a graph showing a relationship between an amount of residual diphosphorus pentasulfide and a stirring time in Example 4.

FIG. 5 is a graph showing a relationship between an amount of residual diphosphorus pentasulfide and a stirring time in Comparative Example 1.

FIG. 6 is a graph showing a relationship between an amount of residual diphosphorus pentasulfide and a stirring time in Comparative Example 4.

FIG. 7 is a graph showing a relationship between an amount of residual diphosphorus pentasulfide and a stirring time in Comparative Example 5.

### DESCRIPTION OF EMBODIMENTS

Hereinafter, an embodiment of the present invention (hereinafter, sometimes referred to as “the present embodiment”) will be described. In addition, in the description herein, the numerical values of the upper limit and the lower limit relating to the numerical range of “or more”, “or less”, and “to” are numerical values that can be arbitrarily combined, and the numerical values of the examples can also be used as the numerical values of the upper limit and the lower limit. Further, the specifications considered to be preferable can be arbitrarily adopted. That is, one specification considered to be preferable can be adopted in combination with one or plurality of other specifications considered to be preferable. It can be said to be more desirable to combine the preferred ones with each other.

### (Findings Obtained by the Inventors to Reach the Present Invention)

As a result of intensive studies to solve the above-described problems, the present inventors have found the following matters, and have completed the present invention.

PTL 1 discloses a method for producing a sulfide solid electrolyte in which a complexing agent containing a compound having at least two tertiary amino groups in the molecule and, if necessary, a solvent are added to a solid electrolyte raw material and mixed.

As a result of intensive studies, the present inventor has found that the ionic conductivity of the obtained solid electrolyte is insufficient or the reaction rate is insufficient depending on the type of the solvent used together with the complexing agent. The insufficient reaction rate immediately leads to a decrease in production efficiency. In addition, when the ionic conductivity is insufficient, the performance as a solid electrolyte becomes insufficient, and there is a possibility that the solid electrolyte does not contribute to practical use. In order to cope with mass production and cost reduction in the future, it is inconvenient even if either one is insufficient, and it is an urgent problem to improve both at the same time.

In the present invention, the complexing agent and the raw material-containing substance form a complex, but the aromatic hydrocarbon solvent has a higher solubility of the complex than the aliphatic hydrocarbon solvent, and thus is considered to improve the reaction rate. However, on the other hand, when only the aromatic hydrocarbon solvent is used as the solvent, it is presumed that the solubility of each complex component is different, so that the uniformity of each complex component is reduced, and as a result, the ionic conductivity of the obtained sulfide solid electrolyte is reduced.

Therefore, the present inventor has found that a sulfide solid electrolyte having excellent quality can be produced while improving the reaction rate by using a combination of an aromatic hydrocarbon solvent and an aliphatic hydrocarbon solvent as a solvent used together with a complexing agent.

### Regarding Various Embodiments of the Present Embodiment

The method for producing a sulfide solid electrolyte according to a first embodiment of the present embodiment is a method for producing a sulfide solid electrolyte including mixing a raw material-containing substance containing a lithium atom, a phosphorus atom, a sulfur atom, and a halogen atom, a complexing agent, an aromatic hydrocarbon solvent, and an aliphatic hydrocarbon solvent.

In the method for producing a sulfide solid electrolyte of the present embodiment, as described above, by using a combination of a complexing agent, an aromatic hydrocarbon solvent, and an aliphatic hydrocarbon solvent when mixing the raw material-containing substance, it is possible to obtain a solid electrolyte having good quality while promoting the reaction between the solid electrolyte raw materials contained in the raw material-containing substance.

The method for producing a sulfide solid electrolyte according to a second embodiment of the present embodiment is the method for producing a sulfide solid electrolyte according to the first embodiment, in which the complexing agent is an amine compound having at least two tertiary amino groups in the molecule.

The method for producing a sulfide solid electrolyte according to a third embodiment of the present embodiment is the method for producing a sulfide solid electrolyte according to the second embodiment, in which the amine compound is a diamine compound having 2 or more and 10 or less carbon atoms.

In an embodiment in which the complexing agent is the amine compound (in particular, the diamine compound), the solid electrolyte raw material contained in the raw material-containing substance is easily dissolved by the combination with the aromatic hydrocarbon solvent, and the reaction rate is further improved.

The method for producing a sulfide solid electrolyte according to a fourth embodiment of the present embodiment is the method for producing a sulfide solid electrolyte according to any one of the first to third embodiments, in which the aromatic hydrocarbon solvent is an aromatic hydrocarbon compound having 6 to 10 carbon atoms.

As the aromatic hydrocarbon solvent, one having 6 to 10 carbon atoms is preferably used from the viewpoint of handling properties such that the melting point is low to some extent and the solvent is in a liquid state in a temperature range during the production process, and availability.

The method for producing a sulfide solid electrolyte according to a fifth embodiment of the present embodiment is the method for producing a sulfide solid electrolyte according to any one of the first to fourth embodiments, in which the aliphatic hydrocarbon solvent is an aliphatic hydrocarbon compound having 6 to 40 carbon atoms.

As the aliphatic hydrocarbon solvent, one having 6 to 40 carbon atoms is preferably used from the viewpoint of handling properties such that the boiling point is high to some extent and the solvent is in a liquid state in a temperature range during the production process, and availability.

The method for producing a sulfide solid electrolyte according to a sixth embodiment of the present embodiment is the method for producing a sulfide solid electrolyte according to any one of the first to fifth embodiments, in which a ratio of an amount of the aromatic hydrocarbon solvent to a total amount of the aromatic hydrocarbon solvent and the aliphatic hydrocarbon solvent is 1.0 to 70.0% by volume.

In the production method of the present embodiment, when the ratio of the aromatic hydrocarbon solvent and the aliphatic hydrocarbon solvent is within the above range, the solid electrolyte raw material contained in the raw material-containing substance is easily dissolved, and the reaction rate is further improved.

The method for producing a sulfide solid electrolyte according to a seventh embodiment of the present embodiment is the method for producing a sulfide solid electrolyte according to any one of the first to sixth embodiments, in which a ratio of an amount of the raw material-containing substance to a total amount of the raw material-containing substance, the aromatic hydrocarbon solvent, and the aliphatic hydrocarbon solvent is 1.0% to 30.0% by mass.

In the production method of the present embodiment, the ratio of the amount of the raw material-containing substance to the total amount of the raw material-containing substance, the aromatic hydrocarbon solvent and the aliphatic hydrocarbon solvent is preferably set within the above range from the viewpoint of setting the concentration at which the productivity can be maintained to some extent while dissolving and reacting the solid electrolyte raw material contained in the raw material-containing substance.

The method for producing a sulfide solid electrolyte according to an eighth embodiment of the present embodiment is the method for producing a sulfide solid electrolyte according to any one of the first to seventh embodiments, in which the raw material-containing substance contains lithium sulfide, phosphorus sulfide, and at least one selected from a lithium halide and a halogen simple substance.

In the production method of the present embodiment, when the raw material-containing substance contains the above-described solid electrolyte raw material, the solid electrolyte raw material is easily dissolved by a combination of the complexing agent, the aromatic hydrocarbon solvent and the aliphatic hydrocarbon solvent, and the reaction rate is further improved.

The method for producing a sulfide solid electrolyte according to a ninth embodiment of the present embodiment is the method for producing a sulfide solid electrolyte according to any one of the first to eighth embodiments, in which an amount of the complexing agent to be used is 0.1 or more and 2.0 or less in terms of a molar ratio of the number of moles of the complexing agent to the number of moles of lithium atoms contained in the raw material-containing substance.

In the production method of the present embodiment, in a case where the molar ratio of the number of moles of the complexing agent to the number of moles of lithium atoms contained in the raw material-containing substance is within the above range, lithium atoms and halogen atoms are highly dispersed by the complexing agent. Therefore, this is preferable from the viewpoint of the quality of the obtained sulfide solid electrolyte.

The method for producing a sulfide solid electrolyte according to a tenth embodiment of the present embodiment is the method for producing a sulfide solid electrolyte according to any one of the first to ninth embodiments, further including heating.

In the production method of the present embodiment, by further heating, the complexing agent is removed from an electrolyte precursor, and an amorphous sulfide solid electrolyte is obtained. By further heating this, a crystalline sulfide solid electrolyte is obtained.

In the production method of the present embodiment, an amorphous sulfide solid electrolyte and a crystalline sulfide solid electrolyte can be produced as desired.

### (Solid Electrolyte)

In the description herein, the “solid electrolyte” means an electrolyte that maintains a solid state at 25 °C under a nitrogen atmosphere. The solid electrolyte in the present embodiment contains a lithium atom, a sulfur atom, a phosphorus atom, and a halogen atom, and has ionic conductivity attributed to the lithium atom.

The “solid electrolyte” includes both an amorphous solid electrolyte and a crystalline solid electrolyte.

In the description herein, the crystalline solid electrolyte is a solid electrolyte in which a peak derived from the solid electrolyte is observed in an X-ray diffraction pattern in X-ray diffractometry, and the presence or absence of a peak derived from a raw material of the solid electrolyte is not considered. That is, the crystalline solid electrolyte includes a crystal structure derived from the solid electrolyte, and a part thereof may be a crystal structure derived from the solid electrolyte, or the whole thereof may be a crystal structure derived from the solid electrolyte. As long as the crystalline solid electrolyte has the X-ray diffraction pattern as described above, a part of the crystalline solid electrolyte may include an amorphous solid electrolyte. Therefore, the crystalline solid electrolyte includes a so-called glass ceramic obtained by heating an amorphous solid electrolyte to a crystallization temperature or higher.

In addition, in the description herein, the amorphous solid electrolyte is one that exhibits a halo pattern in which a peak other than a peak derived from a material is not substantially observed in an X-ray diffraction pattern by an X-ray diffractometry, and the presence or absence of a peak derived from a raw material of the solid electrolyte does not matter.

### [Method for Producing Sulfide Solid Electrolyte]

The method for producing a sulfide solid electrolyte of the present embodiment is a method for producing a sulfide solid electrolyte including mixing a raw material-containing substance containing a lithium atom, a phosphorus atom, a sulfur atom, and a halogen atom, a complexing agent, an aromatic hydrocarbon solvent, and an aliphatic hydrocarbon solvent.

Regarding the production method of the present embodiment, the raw material-containing substance will be explained first.

### (Raw Material-Containing Substance)

The raw material-containing substance used in the present embodiment contains a lithium atom, a sulfur atom, a phosphorus atom, and a halogen atom. More specifically, the raw material-containing substance is a substance containing a substance containing these atoms (hereinafter also referred to as a “solid electrolyte raw material”), and preferably contains two or more kinds of solid electrolyte raw materials.

Typical examples of the solid electrolyte raw material include raw materials containing at least two kinds of atoms selected from the above-mentioned atoms, such as lithium sulfides; lithium halides such as lithium fluoride, lithium chloride, lithium bromide, and lithium iodide; and phosphorus sulfides such as diphosphorus trisulfide (P₂S₃) and diphosphorus pentasulfide (P₂S₅); and raw materials containing one kind of atom selected from the above-mentioned atoms, such as halogen simple substances such as fluorine (F₂), chlorine (Cl₂), bromine (Br₂), and iodine (I₂); and a simple phosphorus substance and a simple sulfur substance.

Among the above examples, as the solid electrolyte raw material containing a lithium atom, a sulfur atom, and a phosphorus atom, lithium sulfide; and phosphorus sulfides such as diphosphorus trisulfide (P₂S₃) and diphosphorus pentasulfide (P₂S₅) are preferable.

Among the above examples, as the solid electrolyte raw material containing a halogen atom, any of a halogen simple substance and a lithium halide can be preferably used.

The halogen atom contained in the raw material-containing substance is preferably a fluorine atom, a chlorine atom, a bromine atom, or an iodine atom, and more preferably a chlorine atom, a bromine atom, or an iodine atom.

In addition, the solid electrolyte raw material containing a halogen atom is preferably selected according to the type of the sulfide solid electrolyte to be obtained. For example, in a case where a sulfide solid electrolyte having a thio-LISICON Region II type crystal structure is to be obtained, bromine (Br₂) and iodine (I₂) are still more preferable among the halogen simple substances, and lithium bromide and lithium iodide are still more preferable among the lithium halides. In the case of attempting to obtain a sulfide solid electrolyte having an argyrodite type crystal structure, chlorine (Cl₂) and bromine (Br₂) are still more preferable among the halogen simple substances, and lithium chloride and lithium bromide are still more preferable among the lithium halides. These solid electrolyte raw materials containing a halogen atom may be used singly or in combination of a plurality of kinds thereof, and it is preferable that a plurality of kinds thereof are used in combination.

As the combination of the solid electrolyte raw materials contained in the raw material-containing substance, for example, a combination of lithium sulfide, phosphorus sulfide, and lithium halide, a combination of lithium sulfide, phosphorus sulfide, and a halogen simple substance, and a combination of lithium sulfide, phosphorus sulfide, lithium halide, and a halogen simple substance are preferably exemplified, and a combination of lithium sulfide, diphosphorus pentasulfide, and lithium halide, and a combination of lithium sulfide, diphosphorus pentasulfide, and a halogen simple substance are more preferably exemplified. In the above combination, lithium chloride, lithium bromide, and lithium iodide are preferable as the lithium halide, and chlorine, bromine, and iodine are preferable as the halogen simple substance. As described above, the solid electrolyte raw material containing a halogen atom can be selected depending on the type of the sulfide solid electrolyte to be obtained.

Examples of the solid electrolyte raw material further include phosphorus halides such as various phosphorus fluorides (PF₃, PF₅), various phosphorus chlorides (PCl₃, PCl₅, P₂Cl₄), various phosphorus bromides (PBr₃, PBrs), and various phosphorus iodides (PI₃, P₂I₄); and thiophosphoryl halides such as thiophosphoryl fluoride (PSF₃), thiophosphoryl chloride (PSCl₃), thiophosphoryl bromide (PSBr₃), thiophosphoryl iodide (PSI₃), thiophosphoryl dichlorofluoride (PSCl₂F), and thiophosphoryl dibromofluoride (PSBr₂F).

Examples of the solid electrolyte raw material include a solid electrolyte raw material containing at least one atom selected from the above atoms and containing atoms other than the atom, more specifically, lithium compounds such as lithium oxide, lithium hydroxide, and lithium carbonate; alkali metal sulfides such as sodium sulfide, potassium sulfide, rubidium sulfide, and cesium sulfide; metal sulfides such as silicon sulfide, germanium sulfide, boron sulfide, gallium sulfide, tin sulfide (SnS, SnS₂), aluminum sulfide, and zinc sulfide; phosphoric acid compounds such as sodium phosphate and lithium phosphate; halides of alkali metals other than lithium, such as sodium halides such as sodium iodide, sodium fluoride, sodium chloride, and sodium bromide; metal halides such as aluminum halide, silicon halide, germanium halide, arsenic halide, selenium halide, tin halide, antimony halide, tellurium halide, and bismuth halide; and phosphorus oxyhalides such as phosphorus oxychloride (POCl₃) and phosphorus oxybromide (POBr₃).

Furthermore, when introducing an oxygen atom into the solid electrolyte, phosphoric acid compounds such as lithium oxide, lithium hydroxide, and lithium phosphate are preferable.

In the present embodiment, Li₃PS₄ having a PS₄ structure can also be used as the solid electrolyte raw material. Specifically, Li₃PS₄ may be prepared by, for example, producing it in advance and used as the raw material. In this case, preferable examples of the combination of the solid electrolyte raw materials contained in the raw material-containing substance include a combination of Li₃PS₄ and the lithium halide, a combination of Li₃PS₄ and the simple halogen, and a combination of Li₃PS₄, the lithium halide, and the simple halogen.

The content of Li₃PS₄ with respect to the total raw materials is preferably 60 to 100 mol %, more preferably 65 to 90 mol %, and still more preferably 70 to 80 mol %. Further, when using Li₃PS₄ and a halogen simple substance, the content of the halogen simple substance with respect to Li₃PS₄ is preferably 1 to 50 mol %, more preferably 10 to 40 mol %, still more preferably 20 to 30 mol %, and yet still more preferably 22 to 28 mol %.

It is preferable that the solid electrolyte raw material such as lithium sulfide used in the present embodiment is particles.

The average particle diameter (D₅₀) of the particles of the solid electrolyte raw material is preferably 0.1 to 1000 μm, more preferably 0.5 to 100 μm, and still more preferably 1 to 20 μm. In the description herein, the average particle diameter (D₅₀) is a particle diameter which reaches 50% (volume-based) of the whole by sequentially integrating particles from the smallest particle diameter when a particle size distribution integration curve is drawn, and is an average particle diameter in which the volume distribution can be measured using, for example, a laser diffraction/scattering type particle size distribution measuring device. In addition, among the above-exemplified raw materials, the solid raw material is preferably a material having an average particle diameter of the same degree as in the aforementioned lithium sulfide particle, namely a material having an average particle diameter falling within the same range as in the aforementioned lithium sulfide particle is preferable.

When the raw material-containing substance contains lithium sulfide, diphosphorus pentasulfide, and lithium halide, the proportion of lithium sulfide with respect to the total of lithium sulfide and diphosphorus pentasulfide is preferably 60 mol % or more, more preferably 65 mol % or more, still more preferably 70 mol % or more, and yet still more preferably 74 mol % or more from the viewpoint of obtaining higher chemical stability and obtaining higher ionic conductivity, and the upper limit thereof is preferably 85 mol % or less, more preferably 83 mol % or less, and still more preferably 80 mol % or less. The range is typically preferably 60 to 85 mol %, more preferably 65 to 83 mol %, still more preferably 70 to 80 mol %, and yet still more preferably 74 to 80 mol %.

In addition, in the case of attempting to obtain a sulfide solid electrolyte having a thio-LISICON Region II type crystal structure, in addition to the above ranges, particularly 74 to 78.5 mol %, 74 to 78 mol %, and 74 to 76 mol % are preferable, and in the case of attempting to obtain a sulfide solid electrolyte having an argyrodite type crystal structure, in addition to the above ranges, particularly 76 to 83 mol %, 77 to 80 mol %, and 78 to 80 mol % are preferable.

In a case where the raw material-containing substance contains lithium sulfide, diphosphorus pentasulfide, lithium halide, and other raw materials used as necessary, the content of lithium sulfide and diphosphorus pentasulfide with respect to the total of these is preferably 50 mol % or more, more preferably 55 mol % or more, and still more preferably 60 mol % or more, and the upper limit thereof is preferably 100 mol % or less, more preferably 90 mol % or less, still more preferably 85 mol % or less, and yet still more preferably 80 mol % or less. The range is typically preferably 50 to 100 mol %, more preferably 55 to 90 mol %, still more preferably 60 to 85 mol %, and yet still more preferably 60 to 80 mol %.

In addition, in the case of attempting to obtain a sulfide solid electrolyte having a thio-LISICON Region II type crystal structure, in addition to the above ranges, particularly 65 to 90 mol %, 70 to 85 mol %, and 75 to 83 mol % are preferable, and in the case of attempting to obtain a sulfide solid electrolyte having an argyrodite type crystal structure, in addition to the above ranges, particularly 50 to 78 mol %, 55 to 70 mol %, and 55 to 65 mol % are preferable.

In a case where the raw material-containing substance contains lithium bromide and lithium iodide in combination as lithium halide, from the viewpoint of improving the ionic conductivity, the proportion of lithium bromide with respect to the total of lithium bromide and lithium iodide is preferably 1 mol % or more, more preferably 20 mol % or more, still more preferably 35 mol % or more, and yet still more preferably 45 mol % or more, and the upper limit thereof is preferably 99 mol % or less, more preferably 90 mol % or less, still more preferably 75 mol % or less, and yet still more preferably 60 mol % or less. The range is typically preferably 1 to 99 mol %, more preferably 20 to 90 mol %, still more preferably 35 to 75 mol %, and yet still more preferably 45 to 60 mol %.

In addition, in the case of attempting to obtain a sulfide solid electrolyte having a thio-LISICON Region II type crystal structure, in addition to the above ranges, particularly 40 to 75 mol %, 40 to 65 mol %, and 45 to 55 mol % are preferable.

In addition, in a case where the raw material-containing substance contains lithium bromide and lithium chloride in combination as lithium halide, from the viewpoint of improving the ionic conductivity, the proportion of lithium bromide with respect to the total of lithium bromide and lithium chloride is preferably 1 mol % or more, more preferably 15 mol % or more, still more preferably 25 mol % or more, and yet still more preferably 35 mol % or more, and the upper limit thereof is preferably 99 mol % or less, more preferably 75 mol % or less, still more preferably 60 mol % or less, and yet still more preferably 45 mol % or less. The range is typically preferably 1 to 99 mol %, more preferably 15 to 75 mol %, still more preferably 25 to 60 mol %, and yet still more preferably 35 to 45 mol %.

In addition, in the case of attempting to obtain a sulfide solid electrolyte having an argyrodite type crystal structure, in addition to the above ranges, particularly 25 to 45 mol % and 35 to 40 mol % are preferable.

When the raw material-containing substance contains a halogen simple substance as a raw material and contains lithium sulfide and diphosphorus pentasulfide, the proportion of the number of moles of lithium sulfide excluding lithium sulfide in the same number of moles as the number of moles of the halogen simple substance with respect to the total number of moles of lithium sulfide and diphosphorus pentasulfide excluding lithium sulfide in the same number of moles as the number of moles of the halogen simple substance is preferably in a range of 60 to 90%, more preferably in a range of 65 to 85%, still more preferably in a range of 68 to 82%, yet still more preferably in a range of 72 to 78%, and particularly preferably in a range of 73 to 77%. This is because when the foregoing proportion falls within the aforementioned ranges, a higher ionic conductivity is obtained.

Further, from the same viewpoint, in a case where the raw material-containing substance contains lithium sulfide, diphosphorus pentasulfide, and a halogen simple substance, the content of the halogen simple substance to the total amount of lithium sulfide, diphosphorus pentasulfide, and the halogen simple substance is preferably 1 to 50 mol %, more preferably 2 to 40 mol %, still more preferably 3 to 25 mol %, and yet still more preferably 3 to 15 mol %.

In a case where the raw material-containing substance contains lithium sulfide, diphosphorus pentasulfide, a halogen simple substance, and lithium halide, the content (α mol %) of the halogen simple substance and the content (β mol %) of the lithium halide to the total amount of the lithium sulfide, the diphosphorus pentasulfide, the halogen simple substance, and the lithium halide preferably satisfy the following formula (2), more preferably satisfy the following formula (3), still more preferably satisfy the following formula (4), and yet still more preferably satisfy the following formula (5).

2≤(2α+β)≤100 (2)

4≤(2α+β)≤80 (3)

6≤(2α+β)≤50 (4)

6≤(2α+β)≤30 (5)

In a case where the raw material-containing substance contains two kinds of halogens as simple substances, assuming that the number of moles of one halogen atom in the substance is A1 and the number of moles of the other halogen atom in the substance is A2, A1:A2 is preferably 1 to 99:99 to 1, more preferably 10:90 to 90:10, still more preferably 20:80 to 80:20, and yet still more preferably 30:70 to 70:30.

In a case where the raw material-containing substance contains two kinds of halogen simple substances, and the two kinds of halogen simple substances are bromine and iodine, assuming that the number of moles of bromine is A1 and the number of moles of iodine is A2, A1:A2 is preferably 1:99 to 99:1, more preferably 20:80 to 80:20, still more preferably 35:65 to 80:20, and yet still more preferably 45:55 to 70:30.

Further, when the two kinds of halogen simple substances are bromine and chlorine, assuming that the number of moles of bromine is B1 and the number of moles of chlorine is B2, B1:B2 is preferably 1:99 to 99:1, more preferably 15:85 to 75:25, still more preferably 25:75 to 60:40, and yet still more preferably 35:45 to 65:55.

In addition, in a case where the raw material-containing substance contains Li₃PS₄, the content of Li₃PS₄ with respect to the total raw materials contained in the raw material-containing substance is preferably 60 to 100 mol %, more preferably 65 to 90 mol %, and still more preferably 70 to 80 mol %.

As described above, Li₃PS₄ prepared by production may be used, and in this case, it is obtained by reacting lithium sulfide and diphosphorus pentasulfide at a molar ratio of 3:1. In a case where Li₃PS₄ is used as the solid electrolyte raw material, for example, the mixing ratio with other raw materials such as a lithium halide and a simple halogen may be in accordance with the case where the above-described lithium sulfide and diphosphorus pentasulfide are used. For example, when lithium sulfide and diphosphorus pentasulfide are reacted at a molar ratio of 3:1, 2 moles of Li₃PS₄ are obtained. Therefore, 2 moles of Li₃PS₄ corresponds to a total amount of 4 moles of lithium sulfide and diphosphorus pentasulfide. Therefore, in the above-described blending ratio in the case where lithium sulfide and diphosphorus pentasulfide are used, the number of moles of lithium sulfide and diphosphorus pentasulfide may be set to twice as many as that of Li₃PS₄ used. In addition, in a case where Li₃PS₄ and a halogen simple substance are used, the amount of the halogen simple substance used with respect to Li₃PS₄ is preferably 1 to 50 mol %, more preferably 10 to 40 mol %, still more preferably 20 to 30 mol %, and yet still more preferably 22 to 28 mol %.

### (Complexing Agent)

The complexing agent used in the present embodiment is a compound capable of forming a complex by coordinating (bonding) with the solid electrolyte raw material contained in the raw material-containing substance, particularly with a lithium atom contained in the raw material-containing substance.

As the complexing agent, any compound having the above-described properties can be used without any particular limitations, and in particular, a compound containing an atom having a high affinity with a lithium atom, for example, a heteroatom such as a nitrogen atom, an oxygen atom, or a chlorine atom is preferable, and a compound having a group containing these heteroatoms is more preferable. This is because these heteroatoms and groups containing the heteroatoms can coordinate (bond) with lithium.

The heteroatom present in the molecule of the complexing agent has a high affinity with a lithium atom and it is considered to have properties of easily forming a complex (hereinafter, also simply referred to as “complex”) by bonding to the solid electrolyte raw materials and the like. Therefore, it is considered that by mixing the solid electrolyte raw material and the complexing agent, a complex is formed, and the dispersion state of the solid electrolyte raw material, especially the dispersion state of halogen atoms, is easily maintained uniformly, and as a result, a sulfide solid electrolyte having high ionic conductivity can be obtained.

Regarding the ability of the complexing agent to form a complex with the solid electrolyte raw materials and the like, it can be directly confirmed by, for example, an infrared absorption spectrum measured by FT-IR analysis (diffuse reflection method).

As a complexing agent, when a powder obtained by stirring tetramethylethylenediamine (hereinafter also simply referred to as “TMEDA”), which is one of the preferable complexing agents, and lithium iodide (LiI), and the complexing agent itself are analyzed by FT-IR analysis (diffuse reflection method), the spectrum is different from that of TMEDA itself, especially in the peak derived from the C—N stretching vibration at 1000 to 1250 cm⁻¹. Furthermore, even considering that it is known that a LiI-TMEDA complex is formed by stirring and mixing TMEDA and lithium iodide (for example, see Aust. J. Chem., 1988, 41, 1925-34, especially FIG. 2), it is reasonable to think that a LiI-TMEDA complex is formed.

Furthermore, for example, when a powder obtained by stirring a complexing agent (TMEDA) and Li₃PS₄ is analyzed by FT-IR analysis (diffuse reflection method) in the same manner as above, it can be confirmed that the spectrum differs from the spectrum of TMEDA itself in the peak derived from the C—N stretching vibration at 1000 to 1250 cm⁻¹, on the other hand it can also be confirmed that the spectrum is similar to that of the LiI-TMEDA complex. From this, it may be considered that a Li₃PS₄-TMEDA complex is formed.

In the production method of the present embodiment, a method for producing a sulfide solid electrolyte by mixing a raw material-containing substance, a complexing agent, an aromatic hydrocarbon solvent, and an aliphatic hydrocarbon solvent to obtain a precursor-containing slurry containing a complex, and then heating the slurry to remove the complexing agent is preferably used.

The complexing agent preferably has at least two heteroatoms which can be coordinated (bonded) in the molecule, and more preferably has a group containing at least two heteroatoms in the molecule. By having a group containing at least two heteroatoms in the molecule, solid electrolyte raw materials and the like can be bonded via at least two heteroatoms in the molecule. Among the heteroatoms, a nitrogen atom and/or an oxygen atom is preferable, an amino group is preferable as a group containing a nitrogen atom, and an ether group is preferable as a group containing an oxygen atom. That is, as the complexing agent, one or more selected from an amine compound and an ether compound are preferable.

The amine compound is not particularly limited as long as it has an amino group in the molecule, since it can promote the formation of a complex. A compound having at least two amino groups in the molecule is preferable, and a compound having at least two tertiary amino groups in the molecule is more preferable. By having such a structure, solid electrolyte raw materials and the like can be bonded via at least two nitrogen atoms in the molecule, to form the complex.

Examples of such an amine compound include amine compounds such as aliphatic amines, alicyclic amines, heterocyclic amines, and aromatic amines, and these amine compounds can be used alone or in combination of a plurality of kinds thereof.

More specifically, as the aliphatic amines, aliphatic primary diamines such as ethylenediamine, diaminopropane, and diaminobutane; aliphatic secondary diamines such as N,N′-dimethylethylenediamine, N,N′-diethylethylenediamine, N,N′-dimethyldiaminopropane, and N,N′-diethyldiaminopropane; aliphatic tertiary diamines such as N,N,N′,N′-tetramethyldiaminomethane, N,N,N′,N′-tetramethylethylenediamine, N,N,N′,N′-tetraethylethylenediamine, N,N,N′,N′-tetramethyldiaminopropane, N,N,N′,N′-tetraethyldiaminopropane, N,N,N′,N′-tetramethyldiaminobutane, N,N,N′,N′-tetramethyldiaminopentane, and N,N,N′,N′-tetramethyldiaminohexane; are representatively preferred. In the examples in the description herein, for example, in the case of diaminobutane, unless otherwise specified, in addition to isomers regarding the position of the amino groups such as 1,2-diaminobutane, 1,3-diaminobutane, and 1,4-diaminobutane, all isomers, such as linear and branched isomers for butane, are included.

The number of carbon atoms of the aliphatic amine is preferably 2 or more, more preferably 4 or more, and still more preferably 6 or more, and the upper limit thereof is preferably 10 or less, more preferably 8 or less, and still more preferably 7 or less. The number of carbon atoms in the aliphatic hydrocarbon group in the aliphatic amine is preferably 2 or more, and the upper limit thereof is preferably 6 or less, more preferably 4 or less, and still more preferably 3 or less.

Typical preferred examples of the alicyclic amines include alicyclic diamines such as alicyclic primary diamines such as cyclopropanediamine and cyclohexanediamine; alicyclic secondary diamines such as bisaminomethylcyclohexane; and alicyclic tertiary diamines such as N,N,N′,N′-tetramethyl-cyclohexanediamine and bis(ethylmethylamino)cyclohexane, and typical preferred examples of the heterocyclic amines include heterocyclic diamines such as heterocyclic primary diamines such as isophoronediamine; heterocyclic secondary diamines such as piperazine and dipiperidylpropane; and heterocyclic tertiary diamines such as N,N-dimethylpiperazine and bismethylpiperidylpropane.

The number of carbon atoms of the alicyclic amine and heterocyclic amine is preferably 3 or more, and more preferably 4 or more, and the upper limit thereof is preferably 16 or less, and more preferably 14 or less.

In addition, typical preferred examples of the aromatic amines include aromatic diamines such as aromatic primary diamines such as phenyldiamine, tolylenediamine, and naphthalenediamine; aromatic secondary diamines such as N-methylphenylenediamine, N,N′-dimethylphenylenediamine, N,N′-bismethylphenylphenylenediamine, N,N′-dimethylnaphthalenediamine, and N-naphthylethylenediamine; and aromatic tertiary diamines such as N,N-dimethylphenylenediamine, N,N,N′,N′-tetramethylphenylenediamine, N,N,N′,N′-tetramethyldiaminodiphenylmethane, and N,N,N′,N′-tetramethylnaphthalenediamine.

The number of carbon atoms of the aromatic amine is preferably 6 or more, more preferably 7 or more, and still more preferably 8 or more, and the upper limit thereof is preferably 16 or less, more preferably 14 or less, and still more preferably 12 or less.

The amine compound used in the present embodiment may be substituted with a substituent such as an alkyl group, an alkenyl group, an alkoxyl group, a hydroxy group, or a cyano group, or a halogen atom.

Although diamine was illustrated as a specific example, it goes without saying that the amine compound that can be used in the present embodiment is not limited to diamine, for example, aliphatic monoamines corresponding to various diamines such as trimethylamine, triethylamine, ethyldimethylamine, and the above aliphatic diamines, also, piperidine compounds such as piperidine, methylpiperidine, and tetramethylpiperidine, pyridine compounds such as pyridine and picoline, morpholine compounds such as morpholine, methylmorpholine, and thiomorpholine, imidazole compounds such as imidazole and methylimidazole, monoamines such as alicyclic monoamines such as monoamines corresponding to the alicyclic diamines, heterocyclic monoamines corresponding to the heterocyclic diamines, and aromatic monoamines corresponding to the aromatic diamines, in addition, for example, polyamines having three or more amino groups such as diethylenetriamine, N,N′,N″-trimethyldiethylenetriamine, N,N,N′,N″,N″-pentamethyldiethylenetriamine, triethylenetetramine, N,N′-bis[(dimethylamino)ethyl]-N,N′-dimethylethylenediamine, hexamethylenetetramine, and tetraethylenepentamine, can also be used.

Among the above, from the viewpoint of obtaining higher ionic conductivity, a tertiary amine having a tertiary amino group as the amino group is preferable, a tertiary diamine having two tertiary amino groups is more preferable, a tertiary diamine having two tertiary amino groups at both ends is still more preferable, and an aliphatic tertiary diamine having tertiary amino groups at both ends is yet still more preferable. In the above amine compound, as the aliphatic tertiary diamine having tertiary amino groups at both ends, tetramethylethylenediamine, tetraethylethylenediamine, tetramethyldiaminopropane, and tetraethyldiaminopropane are preferable, and considering ease of availability, tetramethylethylenediamine and tetramethyldiaminopropane are preferable.

In the production method of the present embodiment, as the complexing agent, in addition to the compound containing a nitrogen atom described above as a heteroatom, a compound containing an oxygen atom is also preferable.

As the compound containing an oxygen atom, a compound having one or more functional groups selected from an ether group and an ester group as a group containing an oxygen atom is preferable, and among these, a compound having an ether group is particularly preferable. That is, as the complexing agent containing an oxygen atom, an ether compound is particularly preferable.

Examples of the ether compound include ether compounds such as aliphatic ethers, alicyclic ethers, heterocyclic ethers, and aromatic ethers, and these ether compounds can be used alone or in combination of a plurality of kinds thereof.

Examples of the aliphatic ether include monoethers such as dimethyl ether, diethyl ether, diisopropyl ether, dibutyl ether, and tert-butyl methyl ether; diethers such as dimethoxymethane, dimethoxyethane, diethoxymethane, and diethoxyethane; polyethers having three or more ether groups, such as diethylene glycol dimethyl ether (diglyme) and triethylene oxide glycol dimethyl ether (triglyme); and ethers containing a hydroxy group, such as diethylene glycol and triethylene glycol.

The number of carbon atoms of the aliphatic ether is preferably 2 or more, more preferably 3 or more, and still more preferably 4 or more, and the upper limit thereof is preferably 10 or less, more preferably 8 or less, and still more preferably 6 or less. The number of carbon atoms of the aliphatic hydrocarbon group in the aliphatic ether is preferably 1 or more, and the upper limit thereof is preferably 6 or less, more preferably 4 or less, and still more preferably 3 or less.

Examples of the alicyclic ether include ethylene oxide, propylene oxide, tetrahydrofuran, tetrahydropyran, dimethoxytetrahydrofuran, cyclopentyl methyl ether, dioxane, and dioxolane, and examples of the heterocyclic ether include furan, benzofuran, benzopyran, dioxene, dioxin, morpholine, methoxyindole, and hydroxymethyldimethoxypyridine.

The number of carbon atoms of the alicyclic ether and heterocyclic ether is preferably 3 or more, and more preferably 4 or more, and the upper limit thereof is preferably 16 or less, and more preferably 14 or less.

Examples of the aromatic ether include methyl phenyl ether (anisole), ethyl phenyl ether, dibenzyl ether, diphenyl ether, benzyl phenyl ether, and naphthyl ether.

The number of carbon atoms of the aromatic ether is preferably 7 or more, and more preferably 8 or more, and the upper limit thereof is preferably 16 or less, more preferably 14 or less, and still more preferably 12 or less.

The ether compound used in the present embodiment may be substituted with a substituent such as an alkyl group, an alkenyl group, an alkoxyl group, a hydroxy group, or a cyano group, or a halogen atom.

Among the above ether compounds, dimethoxyethane and tetrahydrofuran are preferable from the viewpoint of obtaining higher ionic conductivity.

Examples of the ester compound include ester compounds such as aliphatic esters, alicyclic esters, heterocyclic esters, and aromatic esters, and these ester compounds can be used alone or in combination of a plurality of kinds thereof.

More specifically, examples of the aliphatic ester include formic acid esters such as methyl formate, ethyl formate, and triethyl formate; acetic acid esters such as methyl acetate, ethyl acetate, propyl acetate, isopropyl acetate, butyl acetate, and isobutyl acetate; propionic acid esters such as methyl propionate, ethyl propionate, propyl propionate, and butyl propionate; oxalic acid esters such as dimethyl oxalate and diethyl oxalate; malonic acid esters such as dimethyl malonate and diethyl malonate; and succinic acid esters such as dimethyl succinate and diethyl succinate.

The number of carbon atoms of the aliphatic ester is preferably 2 or more, more preferably 3 or more, and still more preferably 4 or more, and the upper limit thereof is preferably 10 or less, more preferably 8 or less, and still more preferably 7 or less. In addition, the number of carbon atoms of the aliphatic hydrocarbon group in the aliphatic ester is preferably 1 or more, and more preferably 2 or more, and the upper limit thereof is preferably 6 or less, more preferably 4 or less, and still more preferably 3 or less.

Examples of the alicyclic ester include methyl cyclohexanecarboxylate, ethyl cyclohexanecarboxylate, dimethyl cyclohexanedicarboxylate, dibutyl cyclohexanedicarboxylate, and dibutyl cyclohexenedicarboxylate, and examples of the heterocyclic ester include methyl pyridinecarboxylate, ethyl pyridinecarboxylate, propyl pyridinecarboxylate, methyl pyrimidinecarboxylate, ethyl pyrimidinecarboxylate, and lactones such as acetolactone, propiolactone, butyrolactone, and valerolactone.

The number of carbon atoms of the alicyclic ester and heterocyclic ester is preferably 3 or more, and more preferably 4 or more, and the upper limit thereof is preferably 16 or less, and more preferably 14 or less.

Examples of the aromatic ester include benzoic acid esters such as methyl benzoate, ethyl benzoate, propyl benzoate, and butyl benzoate; phthalic acid esters such as dimethyl phthalate, diethyl phthalate, dibutyl phthalate, butylbenzyl phthalate, and dicyclohexyl phthalate; and trimellitic acid esters such as trimethyl trimellitate, triethyl trimellitate, tripropyl trimellitate, tributyl trimellitate, and trioctyl trimellitate.

The number of carbon atoms of the aromatic ester is preferably 8 or more, and more preferably 9 or more, and the upper limit thereof is preferably 16 or less, more preferably 14 or less, and still more preferably 12 or less.

The ester compound used in the present embodiment may be substituted with a substituent such as an alkyl group, an alkenyl group, an alkoxyl group, a hydroxy group, or a cyano group, or a halogen atom.

Among the above ester compounds, from the viewpoint of obtaining higher ionic conductivity, an aliphatic ester is preferable, an acetic acid ester is more preferable, and ethyl acetate is particularly preferable.

From the viewpoint of efficiently forming a complex, the amount of the complexing agent to be used is preferably 0.1 or more and 2.0 or less, more preferably 0.5 or more and 1.5 or less, still more preferably 0.8 or more and 1.2 or less, and most preferably 0.9 or more and 1.1 or less in terms of the molar ratio of the number of moles of the complexing agent with respect to the total number of moles of lithium atoms contained in the raw material-containing substance.

### (Aromatic Hydrocarbon Solvent)

As the aromatic hydrocarbon solvent used in the production method of the present embodiment, those having 6 to 10 carbon atoms are preferably used, and more specific examples thereof include alkylbenzenes such as benzene, toluene, xylene, mesitylene, ethylbenzene, and tert-butylbenzene.

### (Aliphatic Hydrocarbon Solvent)

As the aliphatic hydrocarbon solvent used in the production method of the present embodiment, those having 6 to 40 carbon atoms are preferable, and those having 6 to 20 carbon atoms are more preferable, and more specific examples thereof include chain hydrocarbon solvents such as hexane, pentane, 2-ethylhexane, heptane, octane, decane, undecane, dodecane, and tridecane, and alicyclic hydrocarbon solvents such as cyclohexane and methylcyclohexane, and cycloalkane is particularly preferable.

The ratio of the amount of the aromatic hydrocarbon solvent to the total amount of the aromatic hydrocarbon solvent and the aliphatic hydrocarbon solvent is preferably 1.0 to 70.0% by volume, more preferably 10.0 to 60.0% by volume, and still more preferably 25.0 to 50.0% by volume.

The ratio of the amount of the raw material-containing substance to the total amount of the raw material-containing substance, the aromatic hydrocarbon solvent, and the aliphatic hydrocarbon solvent is preferably 1.0 to 30% by mass, more preferably 5.0 to 25.0% by mass, and still more preferably 8.0 to 20.0% by mass.

### (Mixing)

The production method of the present embodiment includes mixing the raw material-containing substance, the complexing agent, the aromatic hydrocarbon solvent, and the aliphatic hydrocarbon solvent.

The method for mixing the raw material-containing substance, the complexing agent, the aromatic hydrocarbon solvent, and the aliphatic hydrocarbon solvent is not particularly limited, and these may be charged into an apparatus capable of mixing these and mixed.

However, when using a halogen simple substance as a solid electrolyte raw material, the solid electrolyte raw material may not be solid, specifically, at room temperature and normal pressure, fluorine and chlorine are gases, and bromine is liquid. In such a case, for example, in a case where the solid electrolyte raw material is a liquid, the solid electrolyte raw material may be supplied into the tank together with a complexing agent and a solvent separately from other solid solid electrolyte raw materials, and in a case where the solid electrolyte raw material is a gas, the solid electrolyte raw material may be supplied so as to be blown into a material obtained by adding a solid solid electrolyte raw material to a complexing agent and a solvent.

The order of charging the raw material-containing substance, the complexing agent, the aromatic hydrocarbon solvent, and the aliphatic hydrocarbon solvent is not particularly limited, and for example, the complexing agent and the raw material-containing substance can be first mixed, and then the aromatic hydrocarbon solvent and the aliphatic hydrocarbon solvent can be charged and mixed, but from the viewpoint of suppressing a side reaction due to excessive contact between the complexing agent and the raw material-containing substance, it is preferable that the raw material-containing substance and at least one of the aromatic hydrocarbon solvent and the aliphatic hydrocarbon solvent are first charged and mixed, and then the complexing agent is charged and mixed.

In the production method of the present embodiment, when the raw material-containing substance, the complexing agent, the aromatic hydrocarbon solvent, and the aliphatic hydrocarbon solvent are mixed, they can be mixed by a method that does not use a device generally called a pulverizer used for the purpose of pulverizing a solid electrolyte raw material, such as a medium-type pulverizer, e.g., a ball mill or a bead mill, and a mixture (precursor-containing slurry) containing a precursor of a solid electrolyte is obtained.

In order to shorten the mixing time for obtaining the precursor or to pulverize the precursor, the raw material-containing substance and the like may be pulverized by a pulverizer at the time of mixing the raw material-containing substance and the like or after mixing the raw material-containing substance and the like once.

Examples of an apparatus for mixing the raw material-containing substance, the complexing agent, the aromatic hydrocarbon solvent, and the aliphatic hydrocarbon solvent include a mechanical stirring type mixer provided with a stirring blade in a tank. Examples of the mechanical stirring type mixer include a high-speed stirring type mixer and a double-arm type mixer, and the high-speed stirring type mixer is preferably used from the viewpoint of increasing the uniformity of the solid electrolyte raw material in the mixture and obtaining higher ionic conductivity. In addition, examples of the high-speed stirring type mixer include a vertical axis rotating type mixer and a lateral axis rotating type mixer, and mixers of any of these types may be used.

Examples of the shape of the stirring blade used in the mechanical stirring type mixer include an anchor type, a blade type, an arm type, a ribbon type, a multi-stage blade type, a double-arm type, a shovel type, a twin-screw blade type, a flat blade type, and a C-blade type. From the viewpoint of improving the uniformity of the solid electrolyte raw material and obtaining higher ionic conductivity, a shovel type, a flat blade type, and a C-blade type are preferable. In addition, in the mechanical stirring type mixer, a circulation line for discharging the stirring target to the outside of the mixer and then returning the stirring target to the inside of the mixer again may be installed. As a result, the raw material having a heavy specific gravity is stirred without sedimentation or retention, and more uniform mixing is possible.

The location of the circulation line to be installed is not particularly limited, however it is preferably installed at a location such that the object to be stirred is discharged from the bottom of the mixer and returned to the top of the mixer. This makes it easier to uniformly stir the solid electrolyte raw material, which easily settles, on the convection caused by circulation. Furthermore, it is preferable that the return port is located below the surface of the liquid of the stirring target. In this way, it is possible to suppress the stirring target from splashing and adhering to the wall surface inside the mixer.

The temperature conditions for mixing the raw material-containing substance, the complexing agent, the aromatic hydrocarbon solvent, and the aliphatic hydrocarbon solvent are not particularly limited, and are, for example, −30 to 100 °C, preferably −10 to 50 °C, and more preferably about room temperature (23 °C) (for example, about room temperature ±5 °C). In addition, the mixing time is about 0.1 to 150 hours, and preferably 1 to 120 hours, more preferably 4 to 100 hours, and still more preferably 8 to 80 hours, from the viewpoint of mixing more uniformly and obtaining higher ionic conductivity.

By mixing the solid electrolyte raw material and the complexing agent, a complex is formed by the solid electrolyte raw materials and the like, and the complexing agent. More specifically, it is considered that in the complex, a lithium atom, a sulfur atom, a phosphorus atom, and a halogen atom contained in the solid electrolyte raw material are directly bonded to each other via and/or not via the complexing agent by the action of these atoms and the complexing agent. That is, in the production method of the present embodiment, the complex obtained by mixing the solid electrolyte raw material and the complexing agent can be said to be composed of the complexing agent, a lithium atom, a sulfur atom, a phosphorus atom, and a halogen atom.

The complex obtained in the present embodiment is not completely dissolved in the complexing agent which is a liquid, but is usually a solid, and thus is obtained as a suspension (precursor-containing slurry) in which the complex is suspended in the solvent containing the complex.

### (Drying)

The production method of the present embodiment may include drying the precursor-containing slurry after the above mixing.

Examples of the drying method include filtration using a glass filter, solid-liquid separation by decantation, and solid-liquid separation using a centrifuge. Specifically, the solid-liquid separation is easily performed by decantation in which the precursor-containing slurry is transferred to a container and the solid is precipitated, and then the complexing agent and the solvent as the supernatant are removed, or filtration using a glass filter having a pore size of, for example, about 10 to 200 m, preferably 20 to 150 m.

In addition, the drying can be performed while heating using a dryer or the like.

The drying of the precursor-containing slurry may be performed under any pressure condition of under pressure, under normal pressure, and under reduced pressure, and is preferably performed under normal pressure or under reduced pressure. In particular, considering drying at a lower temperature, it is preferable to dry using a vacuum pump or the like, under reduced pressure or even under vacuum.

The temperature condition for drying may be a temperature equal to or higher than the boiling points of the remaining complexing agent, aromatic hydrocarbon solvent, and aliphatic hydrocarbon solvent. Specific temperature conditions cannot be determined completely since they may change depending on the type of complexing agent and solvent used, however preferably at 5 °C or higher, more preferably at 10 °C or higher, and still more preferably at 15 °C or higher, and the upper limit is preferably 110 °C or lower, more preferably 85 °C or lower, and still more preferably 70 °C or lower.

In addition, as for the pressure conditions, as described above, it is preferable to be under normal pressure or reduced pressure, and in the case of reduced pressure, specifically, preferably 85 kPa or less, more preferably 80 kPa or less, and still more preferably 70 kPa or less. The lower limit may be a vacuum (0 KPa), and considering ease of pressure adjustment, it is preferably 1 kPa or more, more preferably 2 kPa or more, and still more preferably 3 kPa or more.

In the production method of the present embodiment, when drying is performed, drying may be performed while heating after performing the solid-liquid separation.

Further, in the production method of the present embodiment, drying may or may not be performed. That is, in the production method of the present embodiment, the heating target of the heating to be described later may be the precursor-containing slurry or the electrolyte precursor obtained by drying.

### (Heating)

The method for producing a sulfide solid electrolyte of the present embodiment may further include heating.

The heating includes, for example, heating the precursor-containing slurry obtained by the mixing or the electrolyte precursor obtained by the drying to remove the complexing agent from the electrolyte precursor; heating the precursor-containing slurry or the electrolyte precursor from which the complexing agent has been removed to thereby obtain a crystalline sulfide solid electrolyte; and in a case where an amorphous sulfide solid electrolyte is obtained by removing the complexing agent from the electrolyte precursor, heating the amorphous sulfide solid electrolyte to thereby obtain a crystalline sulfide solid electrolyte.

By heating, the complexing agent in the electrolyte precursor is removed, and a sulfide solid electrolyte containing a lithium atom, a sulfur atom, a phosphorus atom, and a halogen atom is obtained.

Here, the fact that the complexing agent in the electrolyte precursor is removed is supported by the fact that the sulfide solid electrolyte obtained by removing the complexing agent from the electrolyte precursor has the same X-ray diffraction pattern as the sulfide solid electrolyte obtained by a conventional method without using the complexing agent, in addition to the fact that it can be confirmed from the results of the X-ray diffraction pattern, the gas chromatography analysis, and the like that the complexing agent constitutes the electrolyte precursor (complex).

In the production method of the present embodiment, a crystalline sulfide solid electrolyte may be obtained by heating a precursor-containing slurry or an electrolyte precursor, and a sulfide solid electrolyte that can be an amorphous sulfide solid electrolyte may be obtained by heating a precursor-containing slurry or an electrolyte precursor to obtain an amorphous sulfide solid electrolyte and then heating the amorphous sulfide solid electrolyte. That is, according to the production method of the present embodiment, an amorphous sulfide solid electrolyte can also be produced.

In the production method of the present embodiment, whether to obtain an amorphous sulfide solid electrolyte, whether to obtain a crystalline sulfide solid electrolyte, whether to obtain a crystalline sulfide solid electrolyte after obtaining an amorphous sulfide solid electrolyte, or whether to obtain a crystalline sulfide solid electrolyte directly from a precursor-containing slurry or an electrolyte precursor is appropriately selected as desired, and can be adjusted by a heating temperature, a heating time, and the like.

For example, in the case of obtaining an amorphous sulfide solid electrolyte (including the case of removing the complexing agent from the electrolyte precursor), the heating temperature may be determined according to the structure of the crystalline sulfide solid electrolyte obtained by heating the amorphous sulfide solid electrolyte. Specifically, the amorphous sulfide solid electrolyte may be subjected to differential thermal analysis (DTA) using a differential thermal analyzer (DTA apparatus) under a temperature increase condition of 10 °C/min, and the temperature may be set within a range of preferably 5 °C or lower, more preferably 10 °C or lower, and still more preferably 20 °C or lower starting from a peak top temperature of the exothermic peak observed on the lowest temperature side, and the lower limit thereof is not particularly limited, but may be set to a temperature of about [(peak top temperature of the exothermic peak observed on the lowermost temperature side)−40 °C] or higher. By setting the temperature to such a temperature range, an amorphous sulfide solid electrolyte (obtained by removing the complexing agent from the electrolyte precursor) can be obtained more efficiently and reliably.

The heating temperature for obtaining the amorphous sulfide solid electrolyte (including a heating temperature for removing the complexing agent from the electrolyte precursor) varies depending on the structure of the crystalline sulfide solid electrolyte to be obtained, and thus cannot be generally defined. However, the heating temperature is usually preferably 135 °C or lower, more preferably 130 °C or lower, and still more preferably 125 °C or lower. The lower limit thereof is not particularly limited, but is preferably 90 °C or higher, more preferably 100 °C or higher, and still more preferably 105 °C or higher.

In the case of obtaining a crystalline sulfide solid electrolyte, the heating temperature may be determined according to the structure of the crystalline sulfide solid electrolyte, and is preferably higher than the above-described heating temperature for obtaining an amorphous sulfide solid electrolyte, and specifically, the amorphous sulfide solid electrolyte is subjected to differential thermal analysis (DTA) using a differential thermal analyzer (DTA apparatus) under a temperature increase condition of 10 °C/min, and the heating temperature may be set within a range of preferably 5 °C or higher, more preferably 10 °C or higher, and still more preferably 20 °C or higher starting from a peak top temperature of the exothermic peak observed on the lowermost temperature side, and the upper limit thereof is not particularly limited, but may be set to a temperature of about 40 °C or lower. Within such a temperature range, a crystalline sulfide solid electrolyte can be obtained more efficiently and reliably.

The heating temperature for obtaining the crystalline sulfide solid electrolyte varies depending on the composition and structure of the crystalline sulfide solid electrolyte to be obtained and cannot be generally defined, but is usually preferably 130 °C or higher, more preferably 135 °C or higher, and still more preferably 140 °C or higher, and the upper limit thereof is not particularly limited, but is preferably 600 °C or lower, more preferably 550 °C or lower, and still more preferably 500 °C or lower.

The heating time is not particularly limited as long as it is a time for obtaining a desired amorphous sulfide solid electrolyte or crystalline sulfide solid electrolyte, but is, for example, preferably 1 minute or more, more preferably 10 minutes or more, still more preferably 30 minutes or more, and yet still more preferably 1 hour or more. On the other hand, the upper limit of the heating time is not particularly limited, but is preferably 24 hours or less, more preferably 10 hours or less, still more preferably 5 hours or less, and yet still more preferably 3 hours or less.

The heating is preferably performed in an inert gas atmosphere (for example, a nitrogen atmosphere or an argon atmosphere) or in a reduced pressure atmosphere (particularly in a vacuum). For example, an inert gas atmosphere containing a certain concentration of hydrogen may be used. This is because deterioration (for example, oxidation) of the crystalline sulfide solid electrolyte can be prevented.

Although a method for heating is not particularly limited, for example, a method of using a hot plate, a vacuum heating device, an argon gas atmosphere furnace, or a firing furnace can be adopted. Further, industrially, a horizontal dryer or a horizontal vibrating fluidized dryer having a heating unit and a feed mechanism can be used, and they may be selected depending on the processing amount to be heated.

### (Amorphous Sulfide Solid Electrolyte)

The sulfide solid electrolyte obtained by the production method of the present embodiment is any of an amorphous sulfide solid electrolyte or a crystalline sulfide solid electrolyte.

The amorphous sulfide solid electrolyte obtained by the production method of the present embodiment contains a lithium atom, a sulfur atom, a phosphorus atom, and a halogen atom, and representative examples thereof preferably include solid electrolytes composed of lithium sulfide, phosphorus sulfide, and a lithium halide, for example, Li₂S—P₂S₅—LiI, Li₂S—P₂S₅—LiCl, Li₂S—P₂S₅—LiBr, and Li₂S—P₂S₅—LiI—LiBr; and solid electrolytes further containing other atoms such as an oxygen atom and a silicon atom, for example, Li₂S—P₂S₅—Li₂O—LiI and Li₂S—SiS₂—P₂S₅—LiI. From the viewpoint of obtaining higher ionic conductivity, amorphous sulfide solid electrolytes composed of lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr, are preferable, and Li₂S—P₂S₅—LiI—LiBr is more preferable.

The types of atoms constituting the amorphous sulfide solid electrolyte can be determined by, for example, an ICP emission spectrophotometer.

In the amorphous solid electrolyte obtained by the method for producing a solid electrolyte of the present embodiment, the composition ratio (molar ratio) of a lithium atom, a phosphorus atom, a sulfur atom, and a halogen atom is preferably 1.0 to 1.8:0.1 to 0.8:1.0 to 2.0:0.01 to 0.6, more preferably 1.1 to 1.7:0.2 to 0.6:1.2 to 1.8:0.05 to 0.5, and still more preferably 1.2 to 1.6:0.25 to 0.5:1.3 to 1.7:0.08 to 0.4. In addition, in a case where bromine and iodine are used in combination as the halogen atom, the composition ratio (molar ratio) of the lithium atom, the phosphorus atom, the sulfur atom, bromine, and iodine is preferably 1.0 to 1.8:0.1 to 0.8:1.0 to 2.0:0.01 to 0.3:0.01 to 0.3, more preferably 1.1 to 1.7:0.2 to 0.6:1.2 to 1.8:0.02 to 0.25:0.02 to 0.25, more preferably 1.2 to 1.6:0.25 to 0.5:1.3 to 1.7:0.03 to 0.2:0.03 to 0.2, and still more preferably 1.35 to 1.45:0.3 to 0.45:1.4 to 1.7:0.04 to 0.18:0.04 to 0.18. By setting the composition ratio (molar ratio) of lithium atoms, sulfur atoms, phosphorus atoms, and halogen atoms within the above range, it becomes easier to obtain a solid electrolyte with higher ionic conductivity and having a crystal structure to be described later, particularly a thio-LISICON Region II type crystal structure or an argyrodite type crystal structure.

The shape of the amorphous sulfide solid electrolyte is not particularly limited, and examples thereof include a particle shape.

The average particle diameter (D₅₀) of the particle shaped amorphous sulfide solid electrolyte is, for example, 0.01 μm or more, further 0.03 μm or more, 0.05 μm or more, 0.1 m or more, and the upper limit thereof is 200.0 μm or less, further 100.0 μm or less, 10.0 μm or less, 1.0 μm or less, and 0.5 μm or less.

### (Crystalline Sulfide Solid Electrolyte)

The crystalline sulfide solid electrolyte obtained by the production method of the present embodiment may be a so-called glass ceramic obtained by heating an amorphous sulfide solid electrolyte to a crystallization temperature or higher, and examples of a crystal structure thereof include a Li₃PS₄ crystal structure, a Li₄P₂S₆ crystal structure, a Li₇PS₆ crystal structure, a Li₇P₃S₁₁ crystal structure, and a crystal structure having peaks in the vicinity of 2θ=20.2° and in the vicinity of 23.6° (for example, JP 2013-16423 A).

Examples also include a Li₄₋ₓGe₁₋ₓPₓS₄ system thio-LISICON Region II type crystal structure (see Kanno et al., Journal of The Electrochemical Society, 148 (7) A742-746 (2001)), and a crystal structure similar to the Li₄₋ₓGe₁₋ₓPₓS₄ system thio-LISICON Region II type (see Solid State Ionics, 177 (2006), 2721-2725). The crystal structure of the crystalline sulfide solid electrolyte obtained by the production method of the solid electrolyte of the present embodiment is preferably the thio-LISICON Region II type crystal structure among the above, from the viewpoint of obtaining higher ionic conductivity. Herein, the term “thio-LISICON Region II type crystal structure” refers to either a Li₄₋ₓGe₁₋ₓPₓS₄ system thio-LISICON Region II type crystal structure or a crystal structure similar to a Li₄₋ₓGe₁₋ₓPₓS₄ system thio-LISICON Region II type crystal structure. Here, since the sulfide solid electrolyte obtained by the production method of the present embodiment contains a lithium atom, a phosphorus atom, a sulfur atom, and a halogen atom, the sulfide solid electrolyte may not be represented by the compositional formula of “Li₄₋ₓGe₁₋ₓPₓS₄” in the “Li₄₋ₓGe₁₋ₓPₓS₄ system thio-LISICON Region II type”. However, in a case where the sulfide solid electrolyte obtained by the production method of the present embodiment has the same diffraction peak as the above-described “thio-LISICON Region II type crystal structure” (including the above-described “similar crystal structure”), it can be said that the sulfide solid electrolyte obtained by the production method of the present embodiment has a thio-LISICON Region II type crystal structure formed of a lithium atom, a phosphorus atom, a sulfur atom, and a halogen atom. The same applies to the argyrodite type crystal structure to be described later.

The crystalline sulfide solid electrolyte obtained by the production method of the present embodiment may contain the thio-LISICON Region II type crystal structure, or may contain the thio-LISICON Region II type crystal structure as a main crystal; however, from the viewpoint of obtaining higher ionic conductivity, it is preferable that the crystalline sulfide solid electrolyte contains the thio-LISICON Region II type crystal structure as a main crystal. In the description herein, “containing as a main crystal” means that the proportion of the target crystal structure in the crystal structures is 80% or more, and the proportion is preferably 90% or more, and more preferably 95% or more. In addition, from the viewpoint of obtaining higher ionic conductivity, it is preferable that the crystalline sulfide solid electrolyte obtained by the production method of the present embodiment does not contain crystalline Li₃PS₄ ((3-Li₃PS₄).

In the X-ray diffractometry using CuKα line, the diffraction peak of the Li₃PS₄ crystal structure appears, for example, in the vicinity of 2θ=17.5°, 18.3°, 26.1°, 27.3°, and 30.0°, the diffraction peak of the Li₄P₂S₆ crystal structure appears, for example, in the vicinity of 2θ=16.9°, 27.10, and 32.5°, the diffraction peak of the Li₇PS₆ crystal structure appears, for example, in the vicinity of 2θ=15.3°, 25.2°, 29.6°, and 31.0°, the diffraction peak of the Li₇P₃S₁₁ crystal structure appears, for example, in the vicinity of 2θ=17.8°, 18.5°, 19.7°, 21.8°, 23.7°, 25.9°, 29.6°, and 30.0°, the diffraction peak of the Li₄₋ₓGe₁₋ₓPₓS₄ system thio-LISICON Region II type crystal structure appears, for example, in the vicinity of 2θ=20.10, 23.9°, and 29.5°, and the diffraction peak of the crystal structure similar to the Li₄₋ₓGe₁₋ₓPₓS₄ system thio-LISICON Region II type appears, for example, in the vicinity of 2θ=20.2° and 23.6°. Note that these peak positions may be shifted back and forth within a range of 0.5°.

A crystalline sulfide solid electrolyte having the argyrodite type crystal structure having the structural skeleton of the above-described Li₇PS₆, in which a part of P is substituted with Si, is also preferably exemplified.

Examples of the compositional formulas of the argyrodite type crystal structure include crystal structures represented by the compositional formulas Li₇₋ₓP_{1-y}Si_{y}S₆ and Li₇₊ₓP_{1-y}Si_{y}S₆ (x is −0.6 to 0.6, and y is 0.1 to 0.6). The argyrodite type crystal structure represented by this compositional formula is a cubic or orthorhombic, preferably a cubic crystal, and has peaks mainly appearing at positions of 2θ=15.5°, 18.0°, 25.0°, 30.0°, 31.4°, 45.3°, 47.0°, and 52.0° in X-ray diffractometry using CuKα line.

Examples of the compositional formula of argyrodite type crystal structure include a compositional formula of Li_{7-x-2y}PS_{6-x-y}Clₓ (0.8≤x≤1.7, 0<y≤−0.25x+0.5). The argyrodite type crystal structure represented by this compositional formula is preferably a cubic crystal, and has peaks mainly appearing at positions of 2θ=15.5°, 18.0°, 25.0°, 30.0°, 31.4°, 45.3°, 47.0°, and 52.0° in X-ray diffractometry using CuKα line.

Further, examples of the compositional formula of the argyrodite type crystal structure include Li₇₋ₓPS₆₋ₓHₐₓ (Ha is Cl or Br, x is preferably 0.2 to 1.8). The argyrodite type crystal structure represented by this compositional formula is preferably a cubic crystal, and has peaks mainly appearing at positions of 2θ=15.5°, 18.0°, 25.0°, 30.0°, 31.4°, 45.3°, 47.0°, and 52.0° in X-ray diffractometry using CuKα line.

Note that these peak positions may be shifted back and forth within a range of ±0.5°.

In addition, the composition ratio of the atoms contained in the crystalline sulfide solid electrolyte is a composition ratio according to a compositional formula corresponding to each of the above-described various crystal structures, and is preferably within the range of the composition ratio of each atom contained in the above-described amorphous sulfide solid electrolyte. When the composition ratio of each atom is within the range of the composition ratio of each atom, a thio-LISICON Region II type crystal structure or an argyrodite type crystal structure is easily formed among the above-described crystal structures.

### (Properties of Sulfide Solid Electrolyte)

The shape of the sulfide solid electrolyte obtained by the production method of the present embodiment is particulate.

The average particle diameter (D₅₀) of the particulate sulfide solid electrolytes is, for example, 0.01 μm or more, further 0.03 μm or more, 0.05 μm or more, and 0.1 μm or more, and the upper limit thereof is preferably 10 μm or less, more preferably 7.0 μm or less, and still more preferably 4.0 μm or less. As described above, the sulfide solid electrolyte obtained by the production method of the present embodiment has a small average particle diameter in the above range by setting the ratio of the raw material-containing substance and the solvent to a certain value or less.

Therefore, in the production method of the present embodiment, there is no need to perform pulverization (atomization) treatment.

### (Application)

Since the sulfide solid electrolyte obtained by the production method of the present embodiment has excellent coating suitability and can be used for the production of a battery without using a solvent or the like, the sulfide solid electrolyte can efficiently exhibit excellent battery performance. In addition, since the sulfide solid electrolyte has high ionic conductivity and excellent battery performance, the sulfide solid electrolyte is suitably used for a battery.

The sulfide solid electrolyte obtained by the production method of the present embodiment may be used for a positive electrode layer, may be used for a negative electrode layer, or may be used for an electrolyte layer. Each of these layers can be produced by a known method.

In addition, in the battery, a current collector is preferably used in addition to the positive electrode layer, the electrolyte layer, and the negative electrode layer, and a known current collector can be used. For example, a layer obtained by coating a material that reacts with the solid electrolyte, such as Au, Pt, Al, Ti, and Cu, with Au can be used.

### EXAMPLES

Hereinafter, the present invention will be specifically described with reference to Examples, but the present invention is not limited to these Examples.

### (Measurement of Ionic Conductivity)

Using the powders of the sulfide solid electrolytes obtained in Examples and Comparative Examples, circular pellets having diameters of 6 to 10 mm (cross-sectional area S: 0.283 to 0.785 cm²) and heights (L) of 0.1 to 0.3 cm were molded and used as samples. Electrode terminals were taken from the top and bottom of the sample, and measured by an alternating current impedance method at 25 °C (frequency range: 1 MHz to 0.1 Hz, amplitude: 10 mV), and a Cole-Cole plot was obtained. The real part Z′ (Ω) at the point where −Z″ (Ω) becomes minimum in the vicinity of the right end of an arc observed in a region on the high frequency side was defined as the bulk resistance R (Ω) of the electrolyte, and the ionic conductivity σ (S/cm) was calculated according to the following equations.

R=ρ(L/S)

α=1/ρ

### (Measurement of Amount of Residual Diphosphorus Pentasulfide)

The amount of the residual diphosphorus pentasulfide was measured through two-stage normalization based on a spectrum obtained by Raman spectroscopy.

First, the precursor-containing slurry immediately after the preparation (immediately after the addition of the complexing agent) was subjected to the measurement of the Raman spectroscopic spectrum under the measurement conditions described below, and after the background correction was performed on the obtained spectrum, the ratio of the peak intensity derived from diphosphorus pentasulfide to the maximum peak intensity derived from the main solvent (component having the largest amount in the solvent composition) [(peak intensity derived from diphosphorus pentasulfide)/(peak intensity derived from main solvent)] was calculated and set as an initial peak intensity ratio.

Here, the maximum peak position derived from the main solvent is 800±2 cm⁻¹ in the case of cyclohexane and 784±2 cm⁻¹ in the case of toluene. In addition, the peak at 270±2 cm⁻¹ was calculated as the peak derived from diphosphorus pentasulfide.

Further, in the same manner as in the case of the initial peak intensity ratio, the Raman spectroscopic spectrum of the precursor-containing slurry after the elapse of 4 hours from the start of the reaction was also measured, and the ratio of the peak intensity derived from diphosphorus pentasulfide to the maximum peak intensity derived from the main solvent was calculated as a peak intensity ratio after the elapse of 4 hours.

Then, the peak intensity ratio after the elapse of 4 hours to the initial peak intensity ratio [(peak intensity ratio after the elapse of 4 hours)/(initial peak intensity ratio)] was calculated and defined as the amount of residual diphosphorus pentasulfide after the elapse of 4 hours.

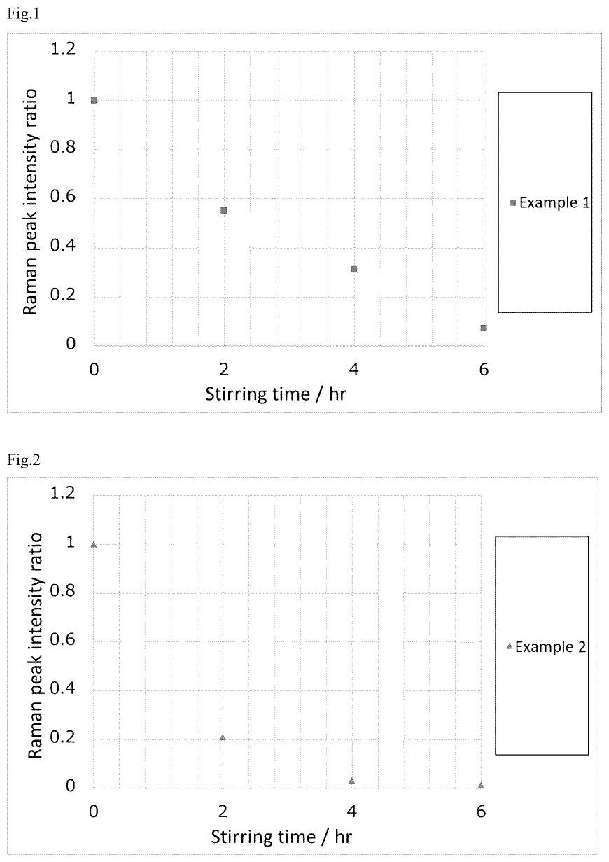

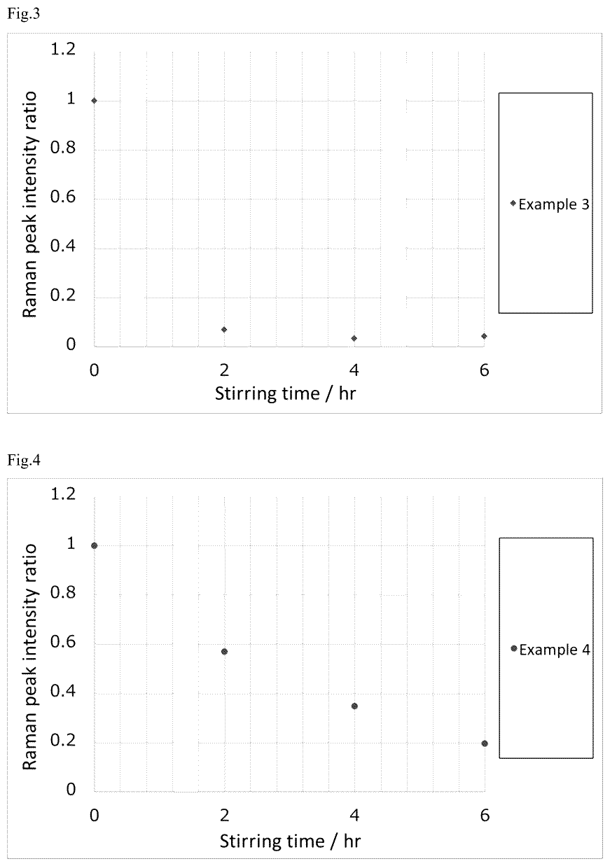

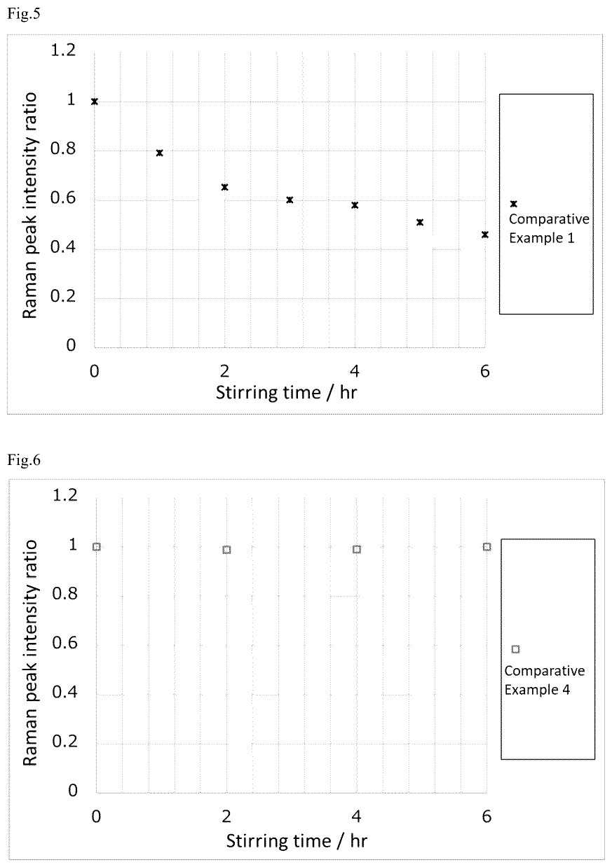

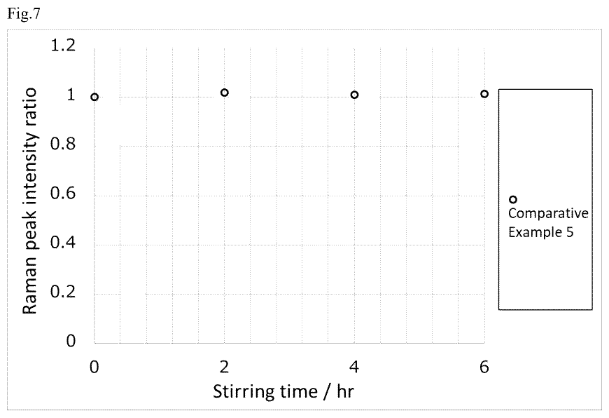

In addition, the results of plotting the amount of residual diphosphorus pentasulfide (Raman peak intensity ratio) with respect to the stirring time are shown in FIG. 1 to FIG. 7.

### [Measurement Conditions]

Model name: HORIBA, Ltd. probe Raman system
Spectrometer: iHR320
Laser wavelength: 785 nm
Exposure time: 10 seconds
Measurement range: 87 cm⁻¹ to 877 cm⁻¹

### Example 1

Into a Schlenk bottle (volume: 100 mL) equipped with a stirring bar, 1.172 g of lithium sulfide, 1.890 g of diphosphorus pentasulfide, 0.369 g of lithium bromide, and 0.569 g of lithium iodide were introduced under a nitrogen atmosphere. After the stirring bar was rotated, 31.0 mL of cyclohexane, 5.0 mL of toluene, and 8.9 mL of tetramethylethylenediamine (TMEDA) as a complexing agent were added, and stirring was continued for 72 hours to obtain a precursor-containing slurry.

The amount of the residual diphosphorus pentasulfide after the elapse of 4 hours measured as described above was 0.33.

The obtained precursor-containing slurry was dried under vacuum (room temperature: 23 °C) to obtain an electrolyte precursor in a powder form.

Next, the powder of the electrolyte precursor was heated under vacuum at 110 °C for 2 hours to obtain an amorphous sulfide solid electrolyte.

Further, the amorphous solid electrolyte was heated under vacuum at 180 °C for 2 hours to obtain a crystalline sulfide solid electrolyte.

The ionic conductivity of the thus obtained crystalline sulfide solid electrolyte was measured and found to be 4.1 mS/cm.

### Examples 2 to 4 and Comparative Examples 1 to 3

A crystalline solid electrolyte was produced in the same manner as in Example 1 except that the amounts of toluene and cyclohexane were changed as shown in Table 1.

The amount of the residual diphosphorus pentasulfide after the elapse of 4 hours and the ionic conductivity of the obtained crystalline sulfide solid electrolyte are shown in Table 1.

### Comparative Example 4

Into a Schlenk bottle (volume: 100 mL) equipped with a stirring bar, 1.172 g of lithium sulfide, 1.890 g of diphosphorus pentasulfide, 0.369 g of lithium bromide, and 0.569 g of lithium iodide were introduced under a nitrogen atmosphere. After the stirring bar was rotated, 45 mL of cyclohexane was added and stirring was continued for 72 hours.

The amount of the residual diphosphorus pentasulfide after the elapse of 4 hours is shown in Table 1.

### Comparative Example 5

Stirring was carried out in the same manner as in Comparative Example 4 except that toluene was used instead of cyclohexane.

The amount of the residual diphosphorus pentasulfide after the elapse of 4 hours is shown in Table 1.

TABLE 1

| | Solvent composition | | | | Measurement results | |
|---|---|---|---|---|---|---|
| | Aromatic hydrocarbon | | Aliphatic | Complexing | Amount of residual | |
| | solvent | | hydrocarbon solvent | agent | diphosphorus | Ionic conductivity |
| | Toluene | Ethylbenzene | Cyclohexane | TMEDA | pentasulfide after | of solid electrolyte |
| | [mL] | [mL] | [mL] | [mL] | elapse of 4 hours | [mS/cm] |
| Example 1 | 5 | | 31 | 8.9 | 0.33 | 4.1 |
| Example 2 | 11 | | 25 | 8.9 | 0.03 | 3.7 |
| Example 3 | 16 | | 20 | 8.9 | 0.05 | 4.1 |
| Example 4 | | 5 | 31 | 8.9 | 0.35 | 4.0 |
| Comparative | | | 36 | 8.9 | 0.60 | 4.1 |
| Example 1 | | | | | | |
| Comparative | 36 | | | 8.9 | | 3.3 |
| Example 2 | | | | | | |
| Comparative | | 36 | | 8.9 | | 2.8 |
| Example 3 | | | | | | |
| Comparative | | | 45 | | 1.0 | |
| Example 4 | | | | | | |
| Comparative | 45 | | | | 1.0 | |
| Example 5 | | | | | | |

As is clear from the comparison between Examples 1 to 4 and Comparative Examples 1 to 3, in Examples 1 to 4 in which a combination of an aromatic hydrocarbon solvent and an aliphatic hydrocarbon solvent was used as a solvent to be used together with a complexing agent, the ionic conductivity of the obtained sulfide solid electrolyte was good, and the peak derived from diphosphorus pentasulfide observed by Raman spectroscopy decreased at an early stage, so that it was found that the reaction rate was also improved.

On the other hand, in Comparative Example 1 in which only the aliphatic hydrocarbon solvent was used as the solvent to be used together with the complexing agent, the decrease in the peak derived from the diphosphorus pentasulfide observed by Raman spectroscopy was small, and the reaction rate was insufficient.

On the other hand, in Comparative Examples 2 and 3 in which only the aromatic hydrocarbon solvent was used as the solvent to be used together with the complexing agent, the ionic conductivity of the obtained sulfide solid electrolyte was insufficient.

In addition, as shown in Comparative Examples 4 and 5, it can be seen that the progress of the reaction cannot be confirmed in any of the aliphatic solvent and the aromatic solvent in a case where the complexing agent is not used, and a difference is observed between the aliphatic solvent and the aromatic solvent only in a case where the complexing agent is used.

### INDUSTRIAL APPLICABILITY

The sulfide solid electrolyte obtained by the production method of the present embodiment is suitably used for batteries used in information-related devices, communication devices, and the like, such as personal computers, video cameras, and mobile phones.

1: A method for producing a sulfide solid electrolyte, comprising mixing a raw material-containing substance containing a lithium atom, a phosphorus atom, a sulfur atom, and a halogen atom, a complexing agent, an aromatic hydrocarbon solvent, and an aliphatic hydrocarbon solvent.

2: The method for producing a sulfide solid electrolyte according to claim 1, wherein the complexing agent is an amine compound having at least two tertiary amino groups.

3: The method for producing a sulfide solid electrolyte according to claim 2, wherein the amine compound is a diamine compound having 2 or more and 10 or less carbon atoms.

4: The method for producing a sulfide solid electrolyte according to claim 1, wherein the aromatic hydrocarbon solvent is an aromatic hydrocarbon compound having 6 to 10 carbon atoms.

5: The method for producing a sulfide solid electrolyte according to claim 1, wherein the aliphatic hydrocarbon solvent is an aliphatic hydrocarbon compound having 6 to 40 carbon atoms.

6: The method for producing a sulfide solid electrolyte according to claim 1, wherein a ratio of an amount of the aromatic hydrocarbon solvent to a total amount of the aromatic hydrocarbon solvent and the aliphatic hydrocarbon solvent is 1.0 to 70.0% by volume.

7: The method for producing a sulfide solid electrolyte according to claim 1, wherein a ratio of an amount of the raw material-containing substance to a total amount of the raw material-containing substance, the aromatic hydrocarbon solvent, and the aliphatic hydrocarbon solvent is 1.0% to 30.0% by mass.

8: The method for producing a sulfide solid electrolyte according to claim 1, wherein the raw material-containing substance contains lithium sulfide, phosphorus sulfide, and at least one selected from the group consisting of a lithium halide and a halogen simple substance.

9: The method for producing a sulfide solid electrolyte according to claim 1, wherein an amount of the complexing agent is 0.1 or more and 2.0 or less in terms of a molar ratio of a number of moles of the complexing agent to a number of moles of lithium atoms contained in the raw material-containing substance.

10: The method for producing a sulfide solid electrolyte according to claim 1, further comprising heating.
